(19) United States
(12) Patent Application Publication
(10) Pub. No.: US 2007/0001475 A1
(43) Pub. Date: Jan. 4, 2007

(54) Truck bed cover corrugator

(76) Inventors: Rory H. Chenowth, Ramona, CA (US); Lynn Chenowth, Rodeo, NM (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/173,335

(22) Filed: Jun. 29, 2005

(51) Int. Cl. B60P 7/02

(52) U.S. Cl. 296/100.09

(57) ABSTRACT

In a truck bed covering system wherein a tarpaulin sheet is retracted from a deployed position to a folded position by contracting a series of attachment bars regularly spaced apart along the length of the sheet in order to form a supporting frame spanning the top of the truck bed perpendicularly to the direction of retraction, flexible strips are interposed between the ends of the bars and biased to form vaulting guides that orderly force the sheet into parallel corrugations, and prevent any pinching of the covering material by the retracting mechanism. The attachment points for the flexible strips are provided by the engagement of the sheet, through eyelets, by a pair of wire running along the sides of the truck bed, by the securing of the strips to the bows, or by a combination of both.

### FIELD OF THE INVENTION

The present invention relates to retractable canvas structures, and more specifically to retractable cover apparatus for an open-topped container such as a truck or trailer bed.

### BACKGROUND

In many jurisdictions, the law requires that trucks and trailers used in the transport of various materials such as sand, gravel, grain, trash or other loose substances have a cargo area fully covered by a tarpaulin sheet or a net in order to prevent transported material to be blown away and cause a driving hazard for following vehicles or dump litter on the highway.

An example of retractable cover mechanism is disclosed in U.S. Pat. No. 6,435,595 Chenowth, which patent is incorporated in its entirety in this specification by this reference.

It has been found that when the parallel beams or bows that span the cargo area and to which the covering sheet is attached at regularly spaced intervals are contracted toward one another while they are being retracted toward the front or back of the cargo compartment, the strips of covering materials between the bows tend to bunch up randomly into odd shapes that sometimes interfere with the orderly and total withdrawal of the cover, or get caught in the withdrawing mechanism.

A prior attempt to avoid these problems is illustrated in FIG. 1. In this prior art mechanism 1, the withdrawing tarpaulin cover 2 is guided into forming regular plications between each set of adjacent bows 3, 4 by pairs of scissor-joint members rotatively connected together at their top ends 7, 8 and to the bows at their lower ends 9, 10. Besides being relatively complex and costly to implement, such a mechanism requires a perfect match between the length of the fully expanded members and the width of the sections of cover fabric between two adjacent bows in order to avoid ripples in the deployed cover.

The instant invention results from an attempt to devise a more practical and less costly mechanism for guiding the withdrawal of a cargo cover into orderly and compact corrugations, and to allow a complete and flat deployment of the cover.

### SUMMARY

One or more series of flexible and arcuate strips are secured between the ends of the framing beams or bows that span a truck cargo area and to which a tarpaulin cover sheet is attached. Each strip is pre-bended to form when contracted by the retracting movement of the bows one or two arches that vault upwardly or horizontally outwardly in order to guide the edges of the cover sheet into regular corrugations of valley and ridges that compact in an orderly manner between the retracting bows, and are kept away from any retracting cables, pulleys, or other parts of the cover deploying and retracting mechanism.

In some embodiments, it is provided that in a covering system wherein a pliable sheet is retracted from a deployed position to a folded position by contracting a series of parallel attachment bars spanning the sheet at spaced-apart locations perpendicularly to the direction of retraction, an improvement to force the sheet into orderly corrugations, said improvement comprising a plurality of flexible strips interposed between said bars. Some embodiments further comprise means for securing opposite ends of said strips to said bars. Some embodiments further comprise a cable running along a side of said sheet, said cable being slidingly connected to median portions of said strips. In some embodiments a first series of said strips are biased to flex into substantially vertical arches. In some embodiments a second series of said strips are biaseded to flex into substantially horizontal arches. In some embodiments the strips are biased to flex into an oblique direction. Some embodiments further comprise a second series of said strips which are biased to flex into substantially horizontal arches. Some embodiments further comprise a first series of said strips oriented to flex into substantially vertical arches. Some embodiments further comprise a second series of said strips oriented to flex into substantially horizontal arches. Some embodiments further comprise said strips being oriented to flex in an oblique direction. In some embodiments a second series of said strips are oriented to flex into substantially horizontal arches.

In some embodiments there is provided a mechanism for retracting a sheet from a deployed position along a folding direction, which comprises a series of attachment bars spanning and secured to said sheet at spaced-apart intervals; and, a plurality of flexible strips interposed between said bars. Some embodiments further comprise means for securing opposite ends of said strips to said bars. Some embodiments further comprise a cable running along a side of said sheet, said cable being slidingly connected to median portions of said strips. In some embodiments a first series of said strips are biased to flex into substantially vertical arches. In some embodiments the strips are biased to flex into an oblique direction. Some embodiments further comprise a second series of said strips being biased to flex into substantially horizontal arches. Some embodiments further comprise a second series of said strips being biased to flex into substantially horizontal arches. Some embodiments further comprise a cable running along a side of said sheet, said cable being slidingly connected to median portions of said strips. In some embodiments a first series of said strips are biased to flex into substantially vertical arches. In some embodiments a second series of said strips are biased to flex into substantially horizontal arches. In some embodiments said strips are biased to flex into an oblique direction. Some embodiments further comprise means for securing opposite ends of said strips to said bars. In some embodiments each of said strips is permanently creased in a common direction proximate opposite extremities. In some embodiments each of said strips is permanently creased in a first direction about a median line.

In some embodiments there is provided a mechanism for retracting a sheet covering a truck bed along a folding direction from deployed position to a corrugatedly folded position, which comprises: a series of attachment bows spanning said truck bed at spaced-apart intervals perpendicularly to said folding direction; a first series of arcuate, flexible strips secured between the ends of adjacent ones of said bows, and oriented to vault upwardly when said bows are contracted toward one another; a second series of gullwing-shaped, flexible strips; a pair of wires running parallely along lateral edges of said sheet, and being slidingly connected to a median portion of each of said gullwing-shaped strips, said gullwing-shaped strips being oriented to form a pair of arches projecting outwardly and substantially horizontally when said bows are contracted toward one another. In some embodiments the second series of flexible strips are secured at opposite extremities to said ends.

In some embodiments there is provided a method for installing an orderly corrugator in a cargo covering system wherein a pliable sheet is retracted from a deployed position to a folded position by contracting a series of parallel attachment bars spanning the sheet at spaced-apart locations perpendicularly to the direction of retraction, wherein said method comprises: deploying said sheet to form a spacing between a first and second of said bars; securing a first portion of a continuous flexible ribbon to a first of said bars; selecting a second portion of said ribbon spaced a distance apart from said first portion, wherein said distance is greater than said spacing; and securing said second portion to said second of said bars. In some embodiments the method further comprises; slidingly connecting a median portion of said ribbon to a cable running along a side of said sheet; wherein said median portion is located between said first and second portions. Some embodiments further comprise; forming a pair of arcuate arches straddling said median portion and between said first and second portions.

### BRIEF DESCRIPTION OF THE DRAWING

FIG. 1 is a perspective view of a mechanism of the prior art;

FIG. 2 is a perspective view of a section of the corrugating mechanism between the ends of two adjacent framing bows, according to an embodiment of the invention;

FIG. 3 is a front view of a partially contracted first type of flexible strip;

FIG. 4 is a top plan view of a partially contracted second type of flexible strip;

FIG. 5 is a side view of the end of a framing bow and associated corrugating strip;

FIG. 6 is a perspective view of an alternate embodiments of the corrugating mechanism;

FIG. 7 is a side view of the U-shaped bracket; and

FIG. 8 is a perspective view of a section of the corrugating mechanism having two spaced apart U-shaped brackets slidingly engaging to the cable.

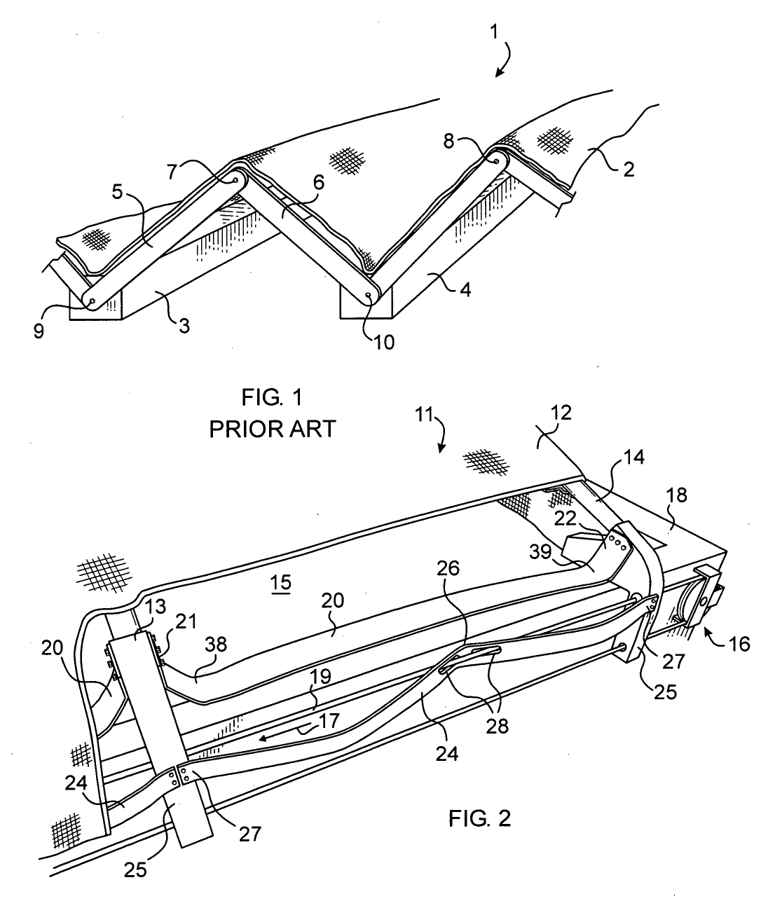

### DESCRIPTION OF THE PREFERRED EMBODIMENTS

Referring now to the drawing, there is shown in FIG. 2 a section 11 of a cargo cover deploying and folding mechanism, not unlike the one disclosed in U.S. Pat. No. 6,435,595 referenced in the Background of the Invention and incorporated in this specification. The pliable tarpaulin sheet 12 is supported by a framework of bars or bows 13, 14 spanning the width of a truck bed 15. The bows are parallel and disposed at regular intervals across the cargo-holding truck bed. A cable and pulley system 16 is used to retract the bows, and the cover 12 that is secured to them, in the direction indicated by the arrow 17 perpendicularly to the orientation of the bows 13, 14. Only the end bow 14 nearest to the front or back 18 of the cargo compartment is fixedly attached to the cable 19. As the end bow 14 is retracted, it pushes all the other ones toward the opposite end of the cargo space.

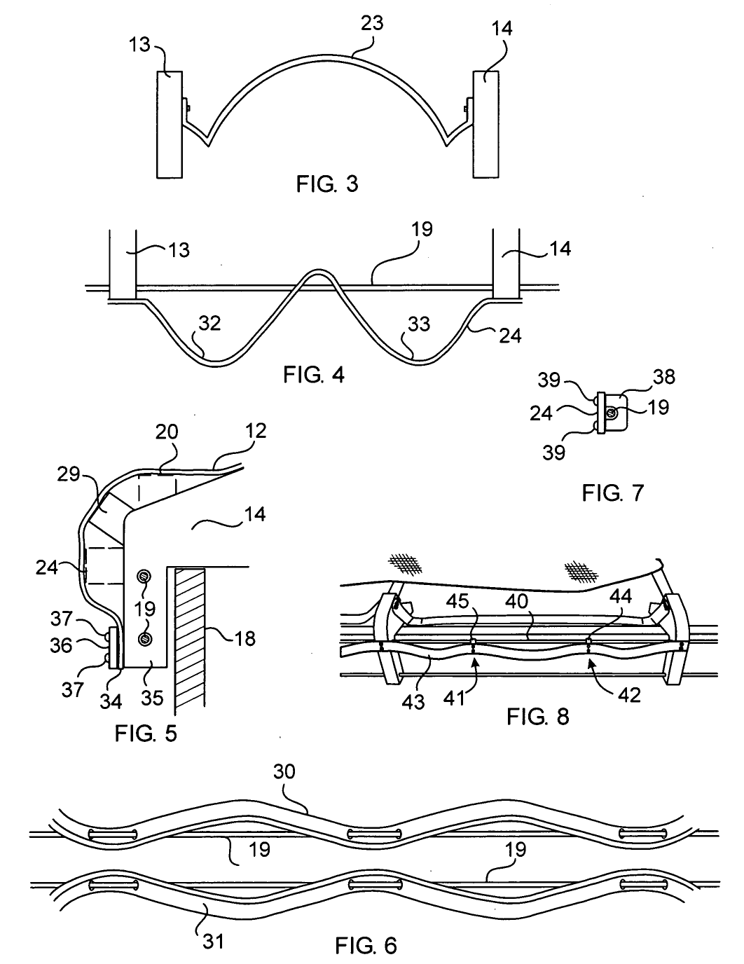

A first series of flexible strips 20 is interposed between the bows. Each strip has its opposite extremities 21, 22 secured by screws to a pair of adjacent bows. The strip is permanently creased 38, 39 in a common direction proximate both extremities, and retains a slight arcuate shape along a broad radius when the cover sheet is fully deployed. The combination of the creases and the orientation of the attachments to the bows bias the strip into a predetermined bending direction. More specifically, as the two bows 13 and 14 are brought together, the strip 20 flexes and vaults upwardly to form an arch 23 as illustrated in FIG. 3. The arch formed by the strip forces the cover sheet 12 to fold in smooth plications or corrugations, and prevents it from falling into and being caught by the cables and gears of the deploying and withdrawing mechanism, caught between the bows and the cargo compartment, or slidingly wear against the cargo compartment. The strips 20 are shown in the drawing as vaulting into a substantially vertical direction. However, depending upon the orientation of their attachments to the bows, they could be made to vault in an oblique or horizontal orientation.

A second series of flexible strips 24 are also interposed between the bows 13, 14. They are secured at their opposite extremities to vertical edges 25 of the bows' ends. These second type of strips are biased by being given a permanent gullwing shape by a permanent crease or fold 26 in a median section and oppositely directed creases 27 near their extremities. The strips 24 are also slidingly connected to the withdrawing cable 19 through two eyelets 28 punched in the median section astride the median line and central fold 26. Due to their orientation and biasing, this second series of strips tend to form two outwardly and horizontally extending bulges which form arches 32,33 as the bows are brought together during the cover withdrawing movement, as shown in FIG. 4.

As illustrated in FIG. 5, a series of flexible strips 29 oriented to vault in an oblique, outward direction could be used singly or in combination with the previously-described first and second series of strips 20, 24 shown in dotted lines in this Figure. The lateral edges 34 of the cover 12 are preferably captured between the outer ends 35 of the bows and a small plate 36 secured by a pair of screws 37.

An alternate arrangement of two series of flexible strips 30,31 is illustrated in FIG. 6. The strips are similar to those in the second series described earlier. Each series of strips is constituted by a continuous flexible ribbon through which the cable 19 of the deploying and withdrawing mechanism is woven in and out. The strips may or may not be attached to the bows. In this embodiment, one strip is oriented to vault upwardly, and the other horizontally and outwardly in the same manner as the two series of FIG. 2.

The cable 19 upon which the strips are slidingly engaged may be the one secured to the first bow that controls the deployment and withdrawal of the cover, or may be an additional pair of static cables or rods.

As illustrated in FIG. 7, the cable 19 may be slidingly connected to a median portion or portions of the strip 24 by at least one small U-shaped bracket 38 which is attached to the strip by a pair of screws 39, instead of passing through the eyelets 28 shown in FIG. 2. FIG. 8 shows that the cable 40 may be slidingly connected to spaced apart median portions 41,42 of the strip 43 by a pair of spaced apart U-shaped brackets 44,45 of the type shown in FIG. 7. This arrangement provides for the strip to extend outward to a lesser distance than previous embodiments and is particularly adapted to systems having relatively large bow spacing when deployed.

The embodiments of FIGS. 7 and 8 are particularly adapted to using a continuous flexible ribbon 43 to form the strips to retrofit existing installations of corrugating cargo cover systems where minor inconsistencies exist the spacing between bows. This present embodiment can readily adapt to these inconsistencies by allowing significant front-to-back latitude in where the ribbon attachment to the bows is made and where the U-shaped brackets are located along the ribbon.

While the preferred embodiment of the invention has been described, modifications can be made and other embodiments may be devised without departing from the spirit of the invention and the scope of the appended claims.

What is claimed is:

1. In a covering system wherein a pliable sheet is retracted from a deployed position to a folded position by contracting a series of parallel attachment bars spanning the sheet at spaced-apart locations perpendicularly to the direction of retraction, an improvement to force the sheet into orderly corrugations, said improvement comprising a plurality of flexible strips interposed between said bars.

2. The improvement of claim 1 which further comprises means for securing opposite ends of said strips to said bars.

3. The improvement of claim 1 which further comprises a cable running along a side of said sheet, said cable being slidingly connected to median portions of said strips.

4. The improvement of claim 2 wherein a first series of said strips are biased to flex into substantially vertical arches.

5. The improvement of claim 2 wherein a second series of said strips are biaseded to flex into substantially horizontal arches.

6. The improvement of claim 2 wherein said strips are biased to flex into an oblique direction.

7. The improvement of claim 4 which further comprises a second series of said strips are biased to flex into substantially horizontal arches.

8. The improvement of claim 3 which further comprises a first series of said strips oriented to flex into substantially vertical arches.

9. The improvement of claim 3 which further comprises a second series of said strips oriented to flex into substantially horizontal arches.

10. The improvement of claim 3 which further comprises said strips are oriented to flex in an oblique direction.

11. The improvement of claim 8 wherein a second series of said strips are oriented to flex into substantially horizontal arches.

12. A mechanism for retracting a sheet from a deployed position along a folding direction, which comprises a series of attachment bars spanning and secured to said sheet at spaced-apart intervals; and, a plurality of flexible strips interposed between said bars.

13. The mechanism of claim 12 which further comprises means for securing opposite ends of said strips to said bars.

14. The mechanism of claim 12 which further comprises a cable running along a side of said sheet, said cable being slidingly connected to median portions of said strips.

15. The mechanism of claim 13 wherein a first series of said strips are biased to flex into substantially vertical arches.

16. The mechanism of claim 13 wherein said strips are biased to flex into an oblique direction.

17. The mechanism of claim 13 which further comprises a second series of said strips are biased to flex into substantially horizontal arches.

18. The mechanism of claim 15 which further comprises a second series of said strips are biased to flex into substantially horizontal arches.

19. The mechanism of claim 18 which further comprises a cable running along a side of said sheet, said cable being slidingly connected to median portions of said strips.

20. The mechanism of claim 14 wherein a first series of said strips are biased to flex into substantially vertical arches.

21. The mechanism of claim 14 wherein a second series of said strips are biased to flex into substantially horizontal arches.

22. The mechanism of claim 14 wherein said strips are biased to flex into an oblique direction.

23. The mechanism of claim 14 which further comprises means for securing opposite ends of said strips to said bars.

24. The mechanism of claim 12 wherein each of said strips is permanently creased in a common direction proximate opposite extremities.

25. The mechanism of claim 14 wherein each of said strips is permanently creased in a first direction about a median line.

26. A mechanism for retracting a sheet covering a truck bed along a folding direction from deployed position to a corrugatedly folded position, which comprises:
a series of attachment bows spanning said truck bed at spaced-apart intervals perpendicularly to said folding direction;
a first series of arcuate, flexible strips secured between the ends of adjacent ones of said bows, and oriented to vault upwardly when said bows are contracted toward one another;
a second series of gullwing-shaped, flexible strips;
a pair of wires running parallely along lateral edges of said sheet, and being slidingly connected to a median portion of each of said gullwing-shaped strips, said gullwing-shaped strips being oriented to form a pair of arches projecting outwardly and substantially horizontally when said bows are contracted toward one another.

27. The mechanism of claim 26 wherein said second series of flexible strips are secured at opposite extremities to said ends.

28. A method for installing an orderly corrugator in a cargo covering system wherein a pliable sheet is retracted from a deployed position to a folded position by contracting a series of parallel attachment bars spanning the sheet at spaced-apart locations perpendicularly to the direction of retraction, wherein said method comprises:
deploying said sheet to form a spacing between a first and second of said bars;
securing a first portion of a continuous flexible ribbon to a first of said bars;
selecting a second portion of said ribbon spaced a distance apart from said first portion, wherein said distance is greater than said spacing; and
securing said second portion to said second of said bars.

29. The method of claim 28 which further comprises;
slidingly connecting a median portion of said ribbon to a cable running along a side of said sheet;
wherein said median portion is located between said first and second portions.

30. The method of claim 29 which further comprises;
forming a pair of arcuate arches straddling said median portion and between said first and second portions.
